(19) United States
(12) Patent Application Publication
(10) Pub. No.: US 2014/0050404 A1
(43) Pub. Date: Feb. 20, 2014

(54) Combining Multiple Image Detectors

(71) Applicants: Jan Erik Solem, San Francisco, CA (US); Oualid Merzouga, Palo Alto, CA (US); Michael Rousson, Palo Alto, CA (US)

(72) Inventors: Jan Erik Solem, San Francisco, CA (US); Oualid Merzouga, Palo Alto, CA (US); Michael Rousson, Palo Alto, CA (US)

(73) Assignee: Apple Inc., Cupertino, CA (US)

(21) Appl. No.: 13/588,639

(22) Filed: Aug. 17, 2012

(51) Int. Cl. G06K 9/46

(52) U.S. Cl. 382/190

(57) ABSTRACT

A technique for combining multiple individual feature detectors to identify a combined feature in a digital image is disclosed. A combined feature detection rule may specify multiple individual feature detectors with which an image is to be analyzed. The multiple individual feature detectors may identify constituent parts of the combined feature and/or may identify features based on different image properties. An analysis of the image with the specified feature detectors may result in the identification of multiple candidate regions (i.e., regions within which the detectors identify their respective features). The combined feature detection rule may operate directly on the multiple candidate regions to adjust the spatial properties of the candidate regions and group the adjusted candidate regions into candidate region groups, it may then be determined if one or more of the candidate region groups is representative of a presence of the combined feature in the image.

### BACKGROUND

This disclosure relates generally to identifying features in an image. More particularly, but not by way of limitation, this disclosure relates to techniques to combine individual feature detectors configured to identify different image properties to obtain robust feature detection.

Digital images can be analyzed to identify certain features of interest in an image. For example, feature detectors may analyze an image to identify faces, people, pets, or other objects of interest. The feature detectors identify certain regions of an image that exhibit properties of the feature that the detector is configured to identify. For example, a face detector may identify portions of an image having characteristic shapes, textures, or colors that are similar to the properties of known faces used to train the detector. However, the properties of a feature of interest may vary widely from image to image. For example, a face in an image captured in bright light may have different properties than the same face in an image captured indoors with lower lighting. Similarly, a forward-looking face may have different properties than a side view of the same face. Moreover, in certain images, features that are important to the detection of a particular feature may be occluded. For example, a face detector that relies on the location of a subject's eyes may not recognize a face in an image where one of a subject's eyes is occluded (e.g., by hair in front of the eye in the image). In light of these limitations, it would be desirable to combine information from multiple individual feature detectors to obtain a robust detector to identify a combined feature in an image.

### SUMMARY

In one embodiment, the invention provides a method to analyze a digital image with multiple feature detectors that are associated with a detection rule to collectively identify a combined feature. The analysis of the digital image by the multiple feature detectors may result in the identification of multiple candidate regions. The detection rule may operate directly on the multiple candidate regions to organize the candidate regions into candidate region groups and to detect the combined feature based on a candidate region group that satisfies the detection rule. An indication of the detected combined feature may be stored in a memory. The method may be embodied in program code and stored on a non-transitory medium.

In another embodiment, the invention provides a method to select multiple individual feature detectors that are each configured to detect a component in a digital image. Each of the individual feature detectors may have corresponding transformation parameters that relate the component to a combined feature. Application of the multiple individual feature detectors to an image may result in the identification of multiple candidate regions. The spatial properties of the candidate regions may be adjusted based on the transformation properties of the individual feature detector that identified the candidate region. It may then be determined that the adjusted candidate regions are indicative of one or more of the combined features in the digital image and an indication of the one or more combined features may be stored in a memory. The method may be embodied in program code and stored on a non-transitory medium.

In yet another embodiment, the invention provides a method to identify multiple candidate regions in an image based on an analysis of the image by multiple feature detectors that are part of a combined feature detection rule. The geometric properties of the candidate regions may be adjusted based on the feature detector that identified the candidate region and the adjusted candidate regions may be clustered into related candidate region groups. One or more combined feature regions may be identified based on the related candidate region groups and an indication of the combined feature regions may be stored in a memory. The method may be embodied in program code and stored on a non-transitory medium.

In still another embodiment, the invention provides a method to receive a selection of a combined feature of interest to be detected in an image. A combined feature detection rule that specifies multiple individual feature detectors may be selected based on the indicated combined feature of interest. An analysis of the image with the multiple individual feature detectors specified in the rule may result in the identification of multiple candidate regions. The candidate regions may be spatially adjusted based on the feature detector that identified the candidate region and grouped into candidate region groups. One or more regions of the image that contain the combined feature of interest may be identified based on the candidate region groups and data that describes the regions may be stored in a memory. The method may be embodied in program code and stored on a non-transitory medium,

### BRIEF DESCRIPTION OF THE DRAWINGS

FIG. 1 illustrates an existing technique for combining multiple individual feature detectors.

FIG. 2 is a flowchart that illustrates a technique for utilizing the raw output of multiple individual feature detectors to identify a combined feature in an image in accordance with one embodiment.

FIG. 3 pictorially illustrates a technique for utilizing the raw output of multiple individual feature detectors to identify a combined feature in an image in accordance with one embodiment.

FIG. 4 illustrates the spatial adjustment of a candidate region identified by an individual feature detector having associated translational and scale transformation parameters in accordance with one embodiment.

FIG. 5 illustrates the spatial adjustment of a candidate region identified by an individual feature detector having associated rotational, translational, and scale transformation parameters in accordance with one embodiment.

FIG. 6 illustrates the grouping of multiple spatially adjusted candidate regions identified by multiple individual feature detectors in accordance with one embodiment.

FIG. 7 is a block diagram for an illustrative electronic device in accordance with one embodiment.

### DETAILED DESCRIPTION

This disclosure pertains to systems, methods, and computer readable media to combine multiple individual image feature detectors into a robust combined featured detector. In general, a combined feature detector may operate directly on the raw output of multiple individual feature detectors that are applied to an image. Each individual feature detector may identify multiple candidate regions (e.g., “hits”) within an image that exhibit one or more properties that the individual detector is trained to identify. A combined feature detector in accordance with this disclosure may operate directly on the candidate regions identified by multiple individual feature detectors to organize the candidate regions into one or more candidate region groups to identify the presence of the combined feature in the image.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the art of image processing having the benefit of this disclosure.

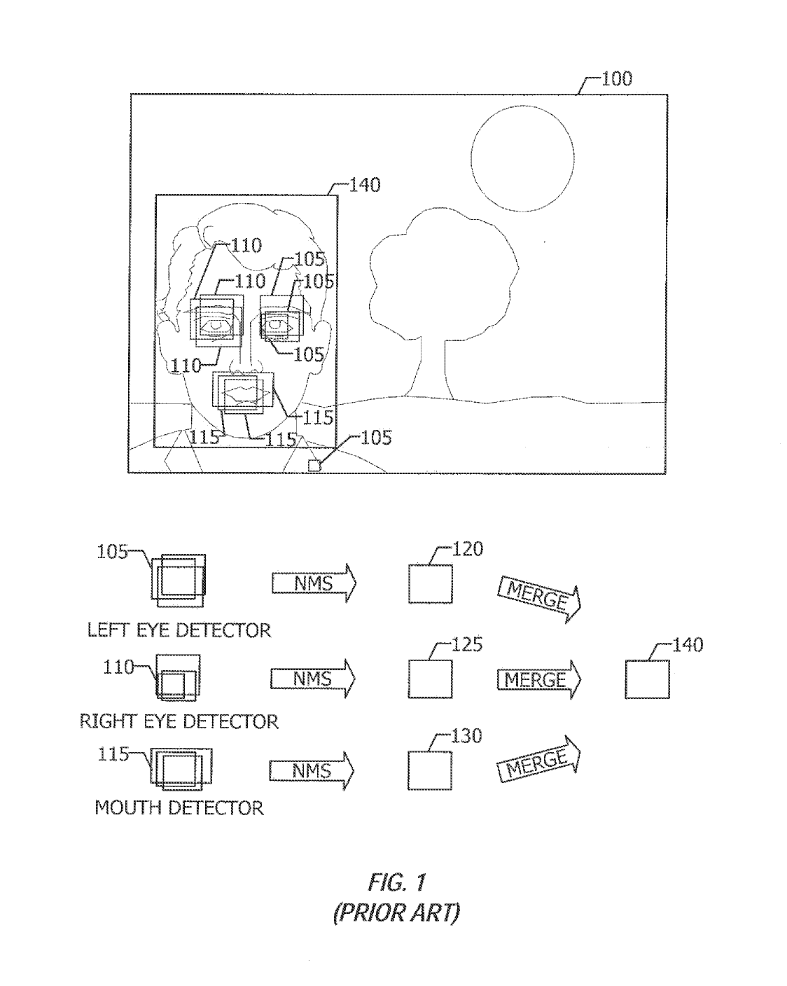

Existing combined feature detectors apply individual detectors to obtain multiple candidate regions, combine the multiple candidate regions for each individual detector through a non-maxima suppression (NMS) process to identify detected feature regions, and merge detected feature regions to identify a combined detected feature region. By way of example, FIG. 1 illustrates the application of filters or classifiers to an image to detect a region of the image that exhibits properties that are consistent with the properties of individual features that the filter or classifier is trained to detect. The classifiers are typically applied to various portions of the image having different sizes, shapes, and/or orientations to identify multiple candidate regions. In this way, a classifier may detect different sizes, orientations, etc. of its particular feature in an image. The results of individual feature detectors may be merged to form a combined feature detector. For example, the results of an analysis of image 100 by a left eye detector, a right eye detector, and a mouth region detector may be combined to identify a face in image 100. In existing rage detection systems, each of the left eye detector, right eye detector, and mouth region detector may be applied to various portions of image 100 as described above and may identify multiple candidate or “hit” regions 105, 110, and 115 respectively. Each candidate region may have a geometric property (e.g., size, shape, and position) as well as an associated confidence property or value. The confidence value may be determined based on the “closeness” between the image properties in a particular candidate region and the properties of “known” or “training” features upon which the detector is based. For each individual detector (e.g., left eye detector, right eye detector, and mouth region detector), the candidate regions may be combined through a non-maxima suppression (NMS) operation to identify individual detected feature regions. The NMS operation may utilize as input the geometric properties and confidence values for the candidate regions of a particular detector. Based on the overlap of multiple candidate regions and their associated confidence values, the NMS operation may detect individual feature regions. For example, the overlapping candidate regions for the left eye detector, right eye detector, and mouth region detector may result in the identification of left eye feature region 120, right eye feature region 125, and mouth feature region 130 based on the NMS operation. The outlier candidate region 105 in image 100 may not result in the identification of a left eye feature region based on a lack of overlapping candidate regions 105 and/or the confidence value associated with the outlier region 105.

The detected feature regions may then be merged to identify a combined feature region 140. The process of merging the detected feature region may be based on predefined rules that define the relative location of detected feature regions with respect to other detected feature regions and allow for the determination of a combined feature region where certain detected feature regions (with certain confidence values) are detected in a certain proximity of each other. For example, a rule may identify face region 140 based on the proximity and positions of feature regions 120, 125, and 130 in image 100.

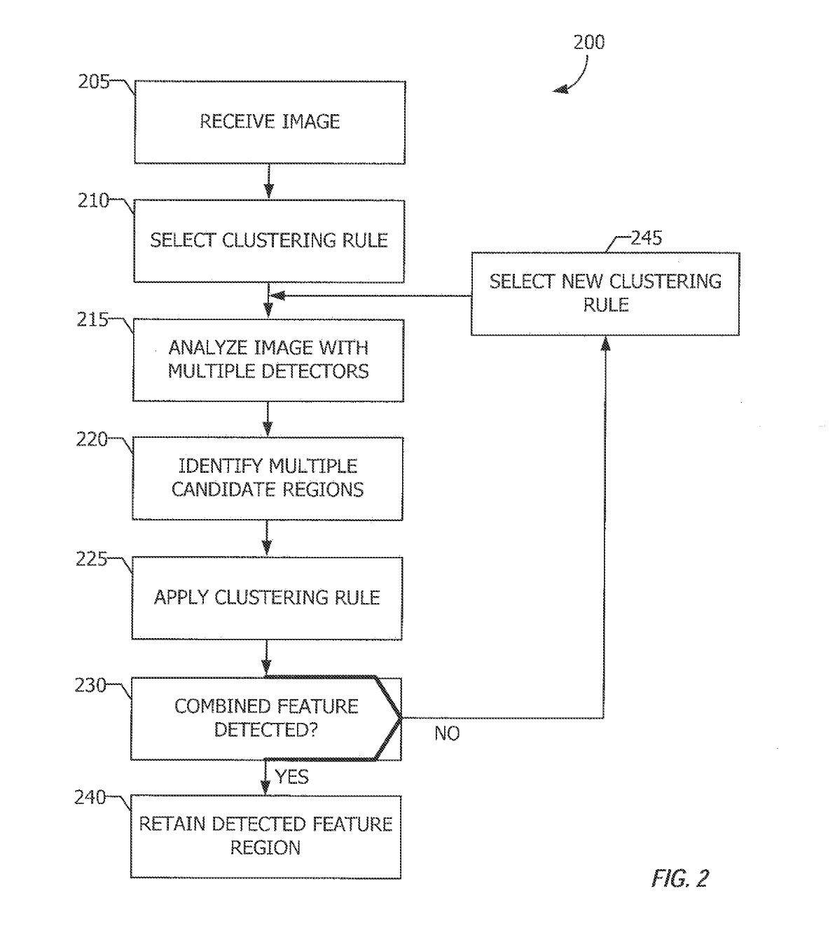

Referring to FIG. 2, combined feature detection operation 200 in accordance with one embodiment operates directly on the raw output of multiple feature detectors to identify a combined feature. Operation 200 may begin with the receipt of an image (block 205). Operation 200 may be performed on an image capture device or on an image editing/viewing/storage device. Consequently, receiving an image may include receiving an image that was captured by an image capture device, receiving an image transferred from an image capture device to another device, receiving an image selected for viewing or editing, etc. Upon receipt, a clustering rule may be selected (block 210). Each clustering rule may be directed to the detection of a specific combined feature and may identify the individual feature detectors to be applied to an image. Accordingly, selection of a clustering rule first involves the selection of a combined feature of interest. For example, certain clustering rules may combine individual feature detectors to identify a face, others may combine individual feature detectors to detect a specific type of pet (e.g., dog, cat, etc.), still others may combine individual feature detectors to identify a person, etc. There may be a number of different clustering rules for each combined feature of interest. For example, different clustering rules to identify a human face may apply different individual feature detectors, may weight detectors differently, etc. Consequently, once a combined feature of interest (e.g., face, pet, person, etc.) has been identified, the selection of a particular clustering rule may be based on various factors. In one embodiment, a clustering rule may be selected based on its computational efficiency. Such a clustering rule may use a small number of individual detectors to identify the combined feature of interest quickly. However, a clustering rule that emphasizes computationally efficiency may have decreased accuracy when compared with more complex clustering rules. Thus, a clustering rule might also be selected on the basis of accuracy. These types of clustering rules may be more appropriate in situations where computational efficiency is not a primary concern. In another embodiment, computationally efficient clustering rules may be used during a first phase to quickly identify which of a number of more accurate (and more computationally expensive) combination rules may be applied in a second phase. It will be understood that more advanced clustering rules may incorporate less advanced clustering rules. For example, a less advanced clustering rule for detecting a human face may apply a left eye detector, a right eye detector, and a mouth region detector whereas a more advanced clustering rule may apply the same detectors and may add an overall face region detector or other additional detectors. As will be described in greater detail below, where one or more detectors associated with a clustering rule identify few candidate regions or identify candidate regions with low associated confidence values (such as when a particular feature is occluded), the clustering rule may still identify the combined feature based on the combined information from the application of the multiple detectors.

After an initial clustering rule has been selected, the image may be analyzed by the multiple feature detectors associated with the selected clustering rule (block 215). As noted above, multiple feature detectors may identify individual parts of a combined feature. For example, individual feature detectors associated with a face detector may identify different facial feature regions (e.g., eyes, upper face, nose, ears, lower face, etc.). Similarly, individual feature detectors associated with a person detector may identify different person feature regions (e.g., face, torso, clothing patters, arms, legs, etc.). Although the multiple feature detectors associated with a clustering rule may identify individual parts of the combined feature, the multiple feature detectors may also identify the same feature based on the detection of different properties. For example, a face detector clustering rule may include a first individual feature detector that identifies an entire face based on color and a second individual feature detector that identifies an entire face based on texture. Accordingly, the individual feature detectors that make up a clustering rule are not necessarily limited to the detection of parts of the combined feature but are instead directed to the detection of features associated with the combined feature.

The analysis of an image with multiple individual feature detectors associated with a selected clustering rule ay result in the identification of multiple candidate regions (block 220). For example, each detector may identify multiple candidate regions within which the image properties resemble the properties that the detector is configured to identify. In contrast to existing multi-detector combination techniques, the clustering rule of operation 200 may be applied directly to the multiple candidate regions associated with each of the individual feature detectors (block 225). Therefore, rather than performing an NMS step to identify individual detected feature regions for the applied individual detectors, the selected clustering rule operates directly on the candidate regions. The clustering rule may be based on hierarchical (agglomerative) clustering, spectral clustering, or complete linkage clustering and may group candidate regions (and exclude outliers) into one or more multi-detector constellations. In one embodiment, each multi-detector constellation may represent the presence of the combined feature in the image. For example, each of multiple faces in an image may be identified by different multi-detector constellations. As will be described in greater detail below, the clustering rule may define spatial parameters that relate each individual detector (and therefore each candidate region detected by the particular detector) to the combined feature. Consequently, the clustering rule may serve to spatially normalize the candidate regions and then group related normalized candidate regions (e.g., based on the proximity of normalized candidate regions) such that they may be evaluated together as part of a multi-detector constellation. After the clustering rule has been applied to the candidate regions, it may be determined if any of the one or more multi-detector constellations corresponds to the location of the combined feature in the image (block 230). The determination of whether the combined feature can be detected based on the multi-detector constellations may be based on the overlap of the clustered candidate regions, the number of candidate regions in the constellation, the number of different types of individual feature detectors that resulted in the identification of the candidate regions that make up the constellation, the confidence level associated with the candidate regions, etc. and may be defined as part of the clustering rule. For example, the clustering rule may define the number of features that need to be identified (as represented by a certain number of candidate regions and associated confidence values in a multi-detector constellation that were identified by a particular feature detector) in order to determine that a multi-detector constellation represents the presence of the combined feature in an image. In one embodiment, a clustering rule may define multiple conditions in which it may be determined that a multi-detector constellation represents the combined feature. For example, the identification of the combined feature may be triggered by a strong (i.e., high confidence) detection by some of the individual detectors with weak or no detection by other individual detectors or by a less strong detection by all or a large portion of the individual detectors.

If it is determined that one or more constellations satisfy the clustering rule, the region of the image associated with the identified combined feature may be maintained (block 240). In one embodiment, the positional coordinates of the region associated with the combined feature may be maintained as image metadata that is stored in a memory together or apart from the image. If, however, it is determined that the candidate regions do not satisfy the clustering rule, a new clustering rule for the combined feature may be selected and the process may be repeated (block 245). For example, a more advanced clustering rule that incorporates additional (or different) individual feature detectors may be selected. In one embodiment, the results of the application of each individual feature detector may be saved such that individual feature detectors that have already been applied to an image and are part of a new clustering rule need not be applied again to the same image.

Application of a clustering rule to the raw output (e.g., candidate regions) of individual feature detectors results in a more robust combination of individual feature detectors to identify a combined feature than any known existing prior art technique. For example, consider the case in which an image depicts a face having a particular region that is partially occluded (e.g., mouth covered by hands, eye covered by hair, etc.). An individual detector that is associated with the partially occluded feature may identify few candidate regions for the feature. Nonetheless, any identified candidate regions associated with the partially occluded feature may become part of a multi-detector constellation based on application of the particular clustering rule and may therefore still contribute to the detection of the combined feature. This is not the case with respect to existing multi-detector combination techniques, such as that described with respect to FIG. 1. An individual feature detector associated with an occluded feature in existing multi-detector combination techniques may be excluded from the combined feature detection by the NMS process. For example, because a detector associated with a partially occluded feature may result in the identification of few candidate regions, the NMS process may not identify a detected feature region for the individual feature, which, in turn, may result in the failure to identify a combined feature that is dependent on the identification of the partially occluded feature.

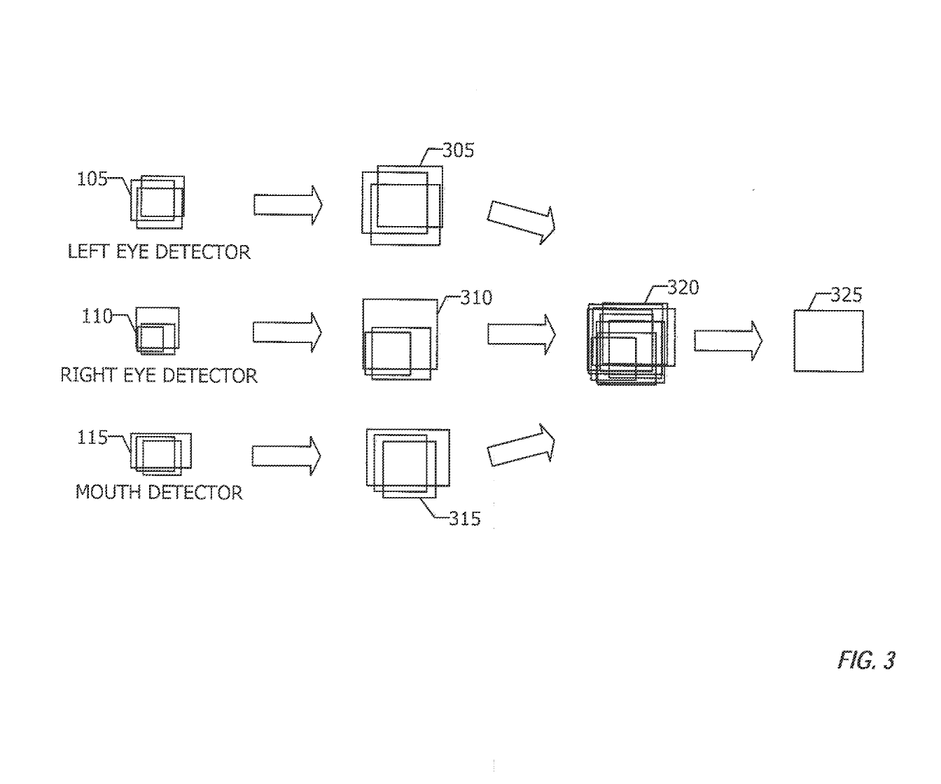

FIG. 3 provides a pictorial representation of the multi-detector combination technique of operation 200. Application of a left eye detector, right eye detector, and mouth region detector to a particular image may result in the identification of multiple candidate regions as described above. However, rather than performing an NMS operation on the candidate regions for each individual detector as in the prior art, the clustering rule of operation 200 may operate directly on the multiple candidate regions detected by the left eye detector, right eye detector, and mouth region detector to form spatially-normalized candidate regions 305, 310, and 315 respectively. As will be described in greater detail below, spatial normalization of the detected candidate regions may include the adjustment of the candidate regions based on geometric properties that relate the individual feature detector to the combined feature as defined in the clustering rule. The clustering of multiple candidate regions may result in the inclusion and exclusion of candidate regions from one or more multi-detector constellations 320, such as, for example, based on the proximity of the spatially-normalized candidate regions. The properties of each candidate region in a constellation as well as the properties of the constellation as a whole may contribute to the identification of combined feature region 325 as corresponding to the location of the combined feature (i.e., a face).

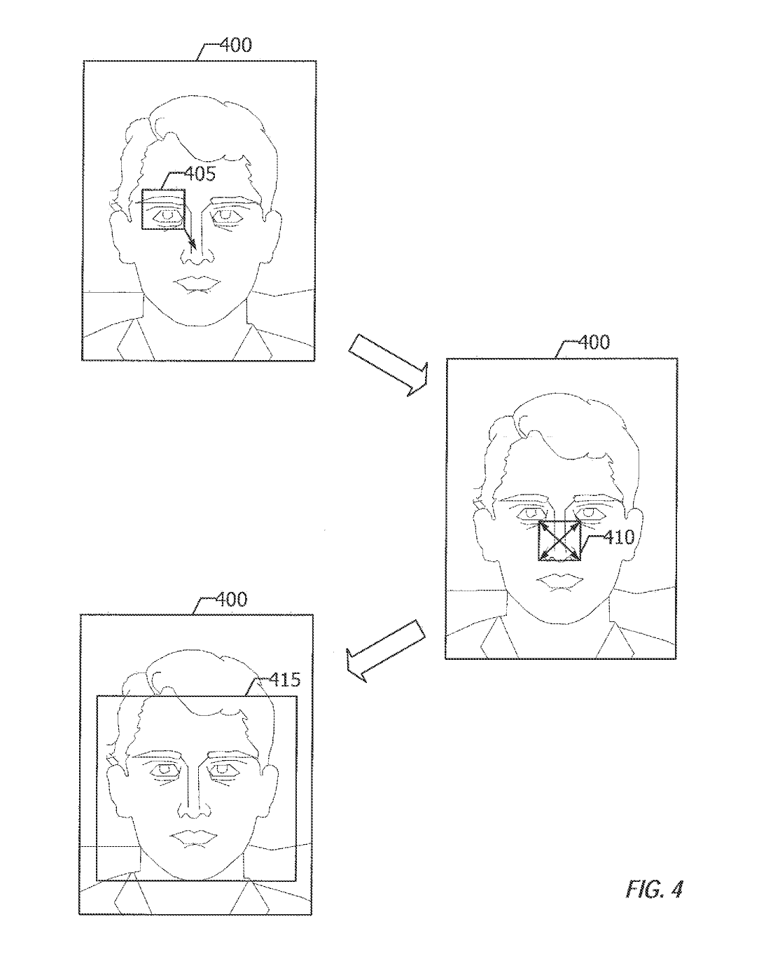

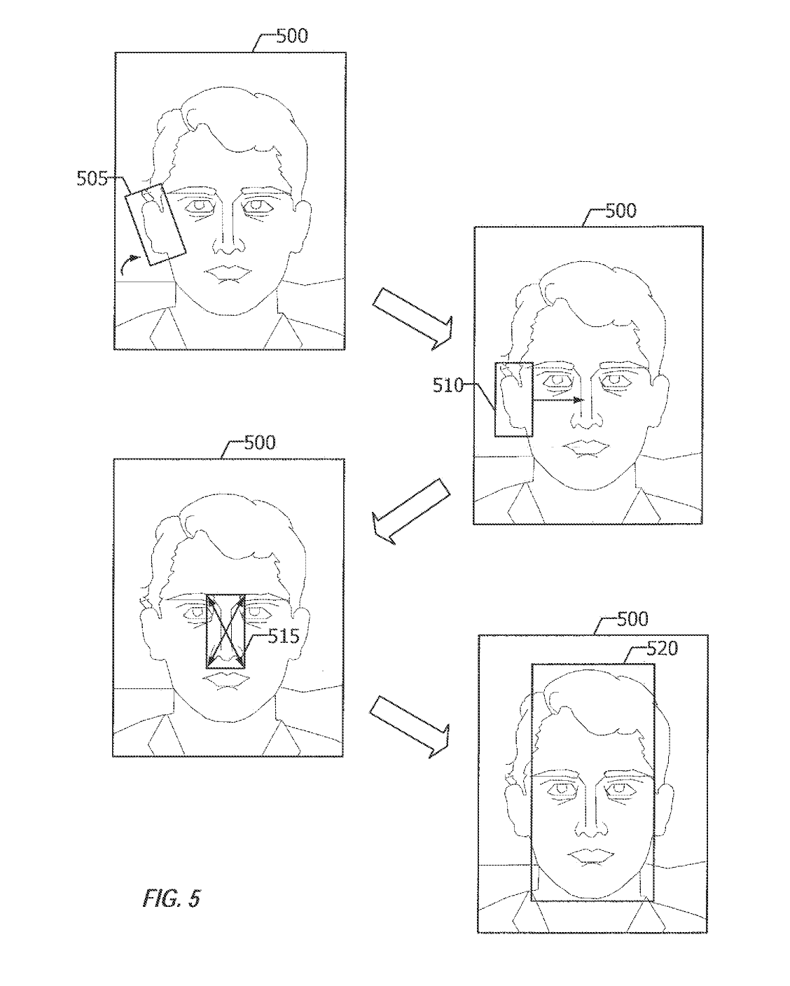

The spatial normalization of candidate regions in accordance with the clustering rules of operation 200 be described with respect to FIGS. 4 and 5. Referring first to FIG. 4, a clustering rule configured to identify a human face may include an individual feature detector configured to identify a right eye. As described above, application of the individual feature detector to image 400 may result in the identification of multiple candidate regions such as, for example, region 405. Each clustering rule may define spatial parameters that relate the individual feature detectors of the clustering rule to the combined feature. For example, the right eye detector of FIG. 4 may be associated with a certain offset from the center of the combined feature (i.e., the face). Moreover, the right eye detector may be associated with a smaller scale than the combined feature. It will be understood that each individual detector may have unique spatial properties with respect to the combined feature. In order to spatially relate each of the individual detectors of a particular clustering rule to a common position, size, and orientation (e.g., the position, size, and orientation of the combined feature), the clustering rule may define transformation parameters for each individual detector and apply the transformation to the candidate regions identified by the individual detectors. In one embodiment, the transformation parameters for each individual detector may be encoded as a triplet having the form (R,t,s) where R defines a rotational component of the individual detector with respect to the combined feature, t defines a translational component of the individual detector with respect to the combined feature, and s defines a scale component of the individual detector with respect to the combined feature. Thus, each individual detector may include its own spatial transformation parameters that relate the detector to the combined feature.

Each identified candidate region (such as region 405) may include several pieces of information. First, each candidate region may have associated geometric properties. These properties may define the position, size, and orientation of the candidate region identified by the detector. In one embodiment, the geometric properties of a candidate region may be defined in terms of a common coordinate system with respect to the analyzed image. Next, the candidate region may have an associated confidence value. As described above, the confidence value for a particular candidate region may be based on the similarity of the image properties within the candidate region as compared to the properties upon which the detector is based (e.g., the similarity between image color in a candidate region as compared to a flesh tone color utilized by a face color detector). It will be understood that confidence values associated with a candidate region will generally increase with an increasing similarity between these properties. Finally, each candidate region may be associated with the individual feature detector that resulted in the identification of the candidate region. Consequently, after analysis of an image by the individual feature detectors specified by a particular clustering rule, multiple candidate regions, each having the above-described properties, may be identified.

Referring back to FIG. 4, the clustering rule may utilize the knowledge of the individual detector that identified candidate region 405 (i.e., the right eye detector) along with the predefined spatial transformation parameters for the particular detector (i.e., with respect to the combined feature of the clustering rule) to transform candidate region 405 to spatially-normalized candidate region 415. In the illustrated embodiment, the transformation parameters associated with the right eye detector for the face detector clustering rule include translational and scale components. The position of candidate region 405 may be adjusted according to the translational component as illustrated by position-adjusted candidate region 410. In one embodiment, the translational component associated with each of the individual feature detectors may adjust a center point of a typical region associated with the individual feature to a center point of a typical region associated with the combined feature. Accordingly, the position of candidate regions identified by each individual detector may be adjusted based on the translational component associated with the individual detector. Because the distance between a common point of a combined feature and a point of an individual feature may differ based on the size of the features in the image, in one embodiment, the magnitude of the translational component may be based on the size of a candidate region associated with a particular individual feature detector. For example, an eye may be a smaller distance away from the center of a face in an image that depicts the face at a greater distance than in an image that depicts the face at a shorter distance.

The scale of position-adjusted candidate region 410 may be adjusted based on a scale component associated with the right eye detector. The scale component of the spatial transformation parameters may represent a relationship between the typical size of a candidate region and a typical size of a combined feature region. For example, the scale component for the right eye detector of FIG. 4 may identify the size of a typical individual candidate region (i.e., a region containing an eye) as one-eighth the size of a typical combined feature region (i.e., a region containing a face). The adjustment of candidate region 405 in accordance with the predefined translational and scale components associated with the right eye detector that identified candidate region 405 produces spatially-normalized candidate region 415.

Referring to FIG. 5, candidate region 505 is identified by a right ear detector that is applied as part of a clustering rule to identify a face in image 500. The right ear detector has predefined associated transformation parameters that include rotational, translational, and scale components. The orientation of candidate region 505 may be adjusted based on the rotational component of the spatial transformation parameters associated with the right ear detector as indicated by orientation-adjusted candidate region 510. The rotational component of the transformation parameters associated with an individual detector may adjust the orientation of a typical individual candidate region to correspond with a typical orientation of a region associated with the combined feature. For example, the rotational component of the right ear detector may identify an angular offset of a typical candidate region with respect to the typically vertical orientation of a detected face. As described above with respect to FIG. 4, the position of orientation-adjusted candidate region 510 may be adjusted based on the translational component of the spatial transformation parameters associated with the right ear detector as indicated by position-adjusted candidate region 515 and the scale of position-adjusted candidate region 515 may be adjusted based on the scale component of the spatial transformation parameters associated with the right ear detector as indicated by spatially-normalized candidate region 520. Although the spatial normalization of candidate regions has been described in terms of an ordered adjustment of the spatial properties of a candidate region for purposes of illustration, it will be understood that adjustment of a candidate region based on the spatial transformation parameters need not occur in a particular order. Moreover, it will be understood that a particular individual feature detector may have associated spatial transformation parameters that include any combination of translational, rotational, and scale components and that these parameters may vary according to the clustering rule in which the individual feature detector is applied. For example, an individual feature detector associated with the identification of a face based on color properties and applied as part of a clustering rule to identify a face may have spatial properties that correspond to the spatial properties of the combined feature region (e.g., the region of the image that includes a face). Accordingly, no spatial transformation of candidate regions identified by the face detector may be necessary with respect to the face detector clustering rule. In contrast, if the same face detector is applied as part of a clustering rule to identify a person, the face detector may have associated translational and scale components (e.g., to adjust the size and position of a face region to the size and position of a person region).

In one embodiment, the spatial transformation parameters associated with an individual feature detector applied as part of a clustering rule may be automatically updated. For example, because the spatial transformation parameters are based on “typical” spatial properties for individual candidate regions as compared to “typical” spatial properties of a combined feature region, as the clustering rule is applied to different images, knowledge of what constitutes “typical” spatial properties of both an individual feature region and a combined feature region may contribute to the automatic adjustment of spatial transformation parameters.

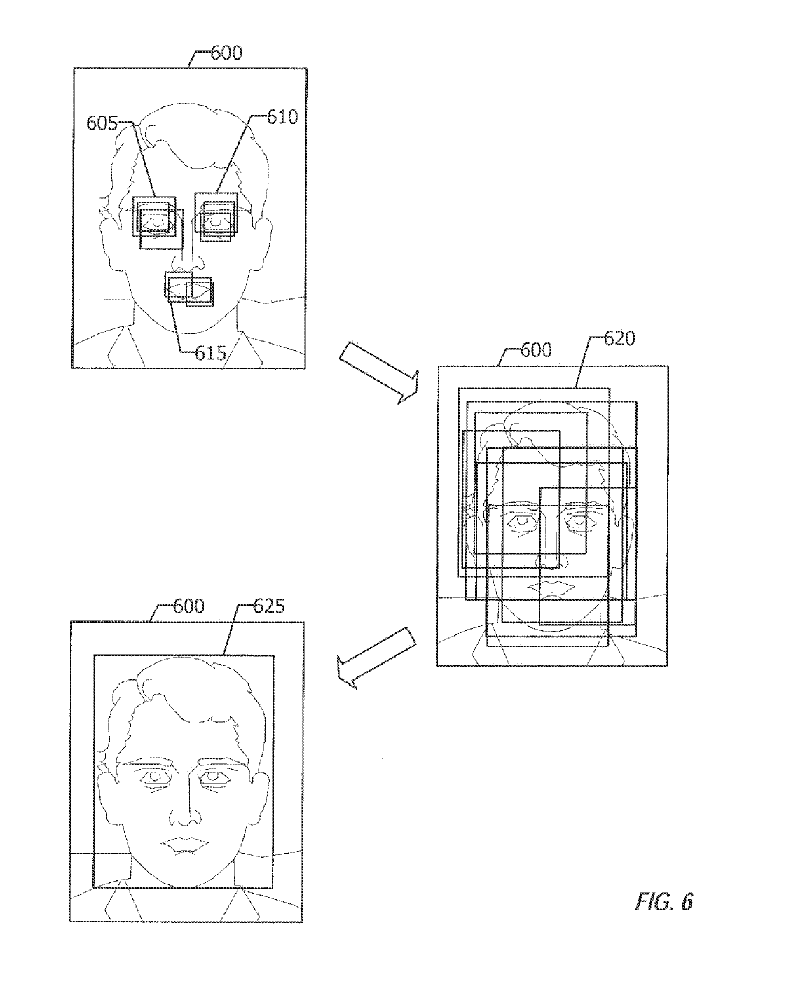

Referring to FIG. 6, candidate regions identified by right eye, left eye, and mouth region detectors (candidate regions 605, 610, and 615 respectively) may each be spatially normalized in accordance with the spatial transformation parameters associated with each individual detector as described above. For purposes of clarity, the individual candidate regions have not been labeled separately. The spatially-normalized candidate regions may be grouped according to a clustering rule such that normalized candidate regions having a certain proximity to other candidate regions are included in multi-detector constellation 620 while outlier candidate regions are excluded from the grouping. The candidate regions forming multi-detector constellation 620 may be analyzed in accordance with the clustering rule to identify combined feature region 625.

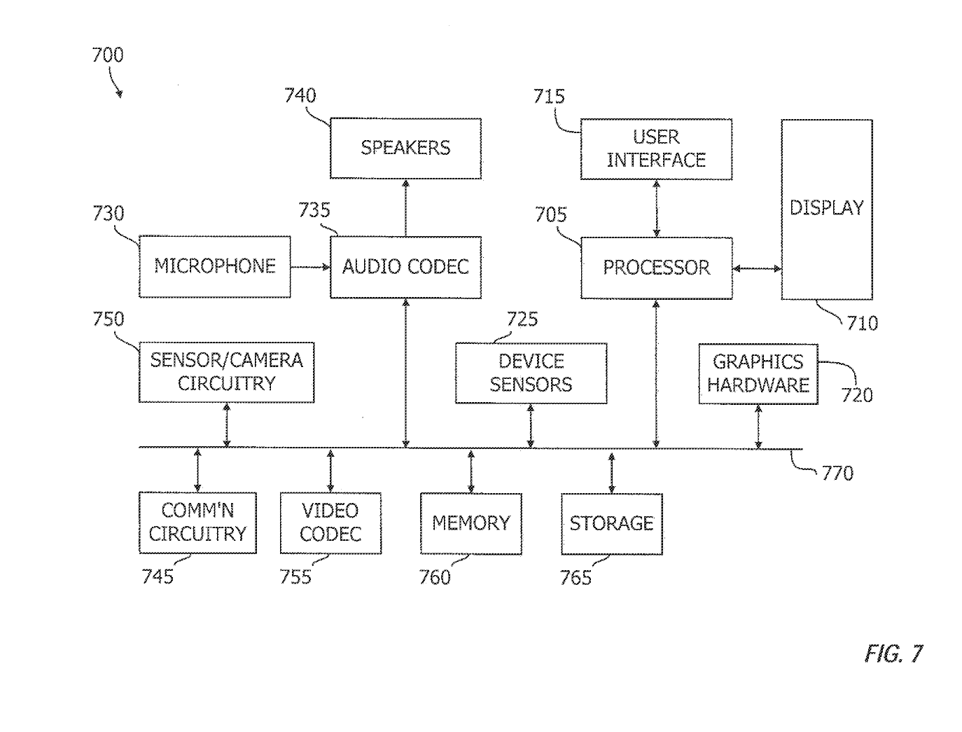

Referring to FIG. 7, a simplified functional block diagram of illustrative electronic device 700 is shown according to one embodiment. Electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, digital image capture unit 750, video codec(s) 755, memory 760, storage 765, and communications bus 770. Electronic device 700 may be, for example, a personal digital assistant (PDA), personal music player, mobile telephone, digital camera, notebook, laptop or tablet computer, desktop computer, or server computer. More particularly, the above-described operations may be performed on a device that takes the form of device 700.

Processor 705 may execute instructions necessary to carry out or control the operation of many functions performed by device 700. Processor 705 may, for instance, drive display 710 and receive user input from user interface 715. User interface 715 can take a variety of forms, such as a button, keypad, dial, a click wheel, keyboard, display screen and/or a touch screen. Processor 705 may also, for example, be a system-on-chip such as those found in mobile devices and include a dedicated graphics processing unit (GPU). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable graphics processing unit (GPU).

Sensor and camera circuitry 750 may capture still and video images that may be processed, at least in part, by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705 and graphics hardware 720 to perform device functions. For example, memory 760 may include memory cache, read-only memory (ROM), and/or random access memory (RAM). Storage 765 may store media (e.g., audio, image and video files), computer program instructions or software, preference information, device profile information, and any other suitable data. Storage 765 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 760 and storage 765 may be used to tangibly retain computer program instructions or code organized into one or ore modules and written in any desired computer programming language. When executed by, for example, processor 705 such computer program code may implement one or more of the methods described herein.

It is to be understood that the above description is intended to be illustrative, and not restrictive. The material has been presented to enable any person skilled in the art to make and use the inventive concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device, readable by a processor and comprising instructions stored thereon to cause the processor to:
analyze a digital image with a plurality of feature detectors, wherein each of the feature detectors is associated with a detection rule to collectively identify a combined feature;
identify a plurality of candidate regions in the digital image, each candidate region associated with one of the feature detectors;
apply the detection rule directly to the candidate regions so as to organize the candidate regions into one or more candidate region groups;
detect the combined feature in the digital image based on at least one of the candidate region groups satisfying the detection rule; and
store an indication of the detected combined feature in a memory.

2. The non-transitory program storage device of claim 1, wherein the instructions to cause the processor to apply the detection rule directly to the candidate regions so as to organize the candidate regions into one or more candidate region groups comprise instructions to cause the processor to spatially normalize the candidate regions.

3. The non-transitory program storage device of claim 2, wherein the instructions to cause the processor to spatially normalize the candidate regions comprise instructions to cause the processor to adjust the spatial properties of at least one of the candidate regions based, at least in part, on predefined spatial transformation parameters of the detection rule.

4. The non-transitory program storage device of claim 3, wherein at least some of the predefined spatial transformation parameters are dependent upon the feature detector with which the candidate region is associated.

5. The non-transitory program storage device of claim 3, wherein at least one of the feature detectors has associated predefined spatial transformation parameters and wherein the predefined spatial transformation parameters for a particular feature detector relate spatial properties of a typical candidate region identified by the feature detector to spatial properties of a typical combined feature region.

6. The non-transitory program storage device of claim 3, wherein the predefined spatial transformation parameters include translational, rotational, and scale components.

7. The non-transitory program storage device of claim 1, wherein the instructions to cause the processor to detect the combined feature in the digital image based on at least one of the candidate region groups satisfying the detection rule comprise instructions to cause the processor to determine that the candidate regions organized into at least one of the one or more candidate region groups exhibit an amount of overlap.

8. The non-transitory program storage device of claim 1, wherein the instructions to cause the processor to detect the combined feature in the digital image based on at least one of the candidate region groups satisfying the detection rule comprise instructions to cause the processor to determine that a number of feature detectors associated with the candidate regions in at least one of the one or more candidate region groups satisfies the detection rule.

9. The non-transitory program storage device of claim 1, wherein each of the feature detectors is configured to identify a constituent part of the combined feature.

10. The non-transitory program storage device of claim 1, wherein two or more of the feature detectors are configured to identify a common feature by evaluating different properties of the digital image.

11. The non-transitory program storage device of claim 1, wherein the instructions to cause the processor to store an indication of the detected combined feature comprise instructions to cause the processor to store an indication of the detected combined feature in a memory with the digital image.

12. A method, comprising:
selecting, by a processor, a plurality of individual feature detectors that are each configured to detect a component in a digital image, each of the individual feature detectors having corresponding transformation parameters that relate the component to a combined feature;
applying, by the processor, each of the individual feature detectors to the digital image to identify a plurality of candidate regions;
adjusting, by the processor, spatial properties of one or more of the candidate regions based on the transformation parameters that correspond to the individual feature detector that identified the candidate region;
determining, by the processor, the adjusted candidate regions are indicative of one or more of the combined features in the digital image; and
storing, by the processor, an indication of the one or more combined features in a memory.

13. The method of claim 12, wherein the act of adjusting spatial parameters of one or more of the candidate regions based on transformation parameters that correspond to the feature detector that identified the candidate region comprises spatially normalizing the candidate regions.

14. The method of claim 12, wherein the transformation parameters that correspond to each of the individual feature detectors relate a typical region associated with the component the individual feature detector is configured to detect to a typical region associated with the combined feature.

15. The method of claim 12, wherein the act of adjusting spatial properties of one or more of the candidate regions comprises adjusting at least one of an orientation, a position, and a scale of one or more of the candidate regions.

16. A non-transitory program storage device, readable by a processor and comprising instructions stored thereon to cause the processor to:
identify a plurality of candidate regions in an image based on an analysis of the image by a plurality of feature detectors specified in a combined feature detection rule, each of the candidate regions having geometric properties and a confidence value;
adjust the geometric properties of one or more of the candidate regions based on the feature detector that identified the candidate region;
duster the adjusted candidate regions into one or more related candidate region groups;
identify one or more combined feature regions in the image based on the one or more related candidate region groups; and
store an indication of the one or more combined feature regions in a memory.

17. The non-transitory program storage device of claim 16, wherein the instructions to cause the processor to adjust the geometric properties of one or more of the candidate regions comprise instructions to spatially normalize the candidate regions.

18. The non-transitory program storage device of claim 16, wherein the instructions to cause the processor to adjust the geometric properties of one or more of the candidate regions based on the feature detector that identified the candidate region comprise instructions to cause the processor to adjust the geometric properties of one or more of the candidate regions based, at least in part, on parameters that relate a typical candidate region associated with the feature detector that identified the candidate region to a typical combined feature region.

19. The non-transitory program storage device of claim 16, wherein the instructions to cause the processor to adjust the geometric properties of one or more of the candidate regions based on the feature detector that identified the candidate region comprise instructions to cause the processor to adjust at least one of a scale, an orientation, and a position of the one or more candidate regions.

20. The non-transitory program storage device of claim 16, wherein the instructions to cause the processor to duster the adjusted candidate regions into one or more related candidate region groups comprise instructions to cause the processor to group the adjusted candidate regions based, at least in part, on a proximity of the adjusted candidate regions.

21. The non-transitory program storage device of claim 16, wherein the instructions to cause the processor to identify one or more combined feature regions in the image based on the one or more related candidate region groups comprise instructions to cause the processor to evaluate an amount of overlap of the adjusted candidate regions in the one or more related candidate region groups.

22. The non-transitory program storage device of claim 16, wherein the instructions to cause the processor to identify one or more combined feature regions in the image based on the one or more related candidate region groups comprise instructions to cause the processor to evaluate the confidence value of the adjusted candidate regions in the one or more related candidate region groups.

23. The non-transitory program storage device of claim 16, wherein each of the feature detectors specified in the combined feature detection rule is configured to detect a constituent part of the combined feature region.

24. The non-transitory program storage device of claim 16, wherein the instructions to cause the processor to store an indication of the one or more combined feature regions in a memory comprise instructions to cause the processor to store an indication of the one or more combined feature regions in a memory with the image.

25. A non-transitory program storage device, readable by a processor and comprising instructions stored thereon to cause the processor to:
receive a selection of a combined feature of interest to be detected in an image;
select a combined feature detection rule configured to identify the combined feature of interest, the combined feature detection rule specifying a plurality of feature detectors;
analyze the image with the plurality of feature detectors specified in the combined feature detection rule to identify a plurality of candidate regions;
spatially adjust the plurality of candidate regions based on the feature detector that identified the candidate regions;
group the spatially adjusted candidate regions into one or more candidate region groups;
identify one or more regions of the image that include the combined feature of interest based on the one or more candidate region groups; and
save data that describes the one or more regions of the image that include the combined feature of interest in a memory.
